(19) United States
(12) Patent Application Publication
(10) Pub. No.: US 2024/0327937 A1
(43) Pub. Date: Oct. 3, 2024

(54) PROCESSES AND METHODS FOR THE PRODUCTION OF IRON AND STEEL

(71) Applicant: CALIX LTD, Pymble, New South Wales (AU)

(72) Inventors: Mark SCEATS, Pymble (AU); Andrew ADIPURI, Pymble (AU); Matthew BOOT-HANDFORD, Pymble (AU); Matthew GILL, Pymble (AU); Thomas DUFTY, Pymble (AU); Adam VINCENT, Pymble (AU)

(73) Assignee: CALIX LTD, Pymble, New South Wales (AU)

(21) Appl. No.: 18/701,877

(22) PCT Filed: Oct. 18, 2022
(86) PCT No.: PCT/AU2022/051250

§ 371 Date: Apr. 16, 2024

(30) Foreign Application Priority Data
Oct. 18, 2021 (AU) 2021903330
May 27, 2022 (AU) 2022901433
Oct. 14, 2022 (AU) 2022903022

(51) Int. Cl. C21B 13/02; C21B 13/00

(52) U.S. Cl. CPC C21B 13/026; C21B 13/0033; C21B 13/0073; C21B 2100/22; C21B 2100/44

(57) ABSTRACT

An externally heated vertical reactor for reduction of iron ore, the reactor including: (a) a reactor tube positioned vertically adjacent to a furnace; (b) an external furnace positioned vertically adjacent at least one wall of the reactor tube to provide heat to be conducted through the at least one wall; (c) an input port at a base of the reactor tube, wherein the reducing gases are heated and injected into the input port such that the reducing gases rise upward through the reactor tube; (d) a gas exhaust positioned adjacent a top surface of the reactor; (e) a gas filter positioned adjacent an entrance to the gas exhaust; and (f) a bed positioned at the base of the reactor tube, wherein the reduced iron powder product is collected in the bed at the base of the reactor tube.

### TECHNICAL FIELD

The present invention relates broadly to providing a number of means for the manufacture of iron and steel production. Generally, the process described herein is a method for producing iron by the Direct Reduction of Iron process from a wide range of iron ore powders, such as hematite, magnetite and goethite using indirect heating of DRI Reactors, and specifically the process is directed towards lowering CO₂ emissions for the production of steel using hydrogen as the reductant for indirectly heated H-DRI Reactors and preferably, using renewable electricity for indirect heating. Also described is the use of these reactors to upgrade low-grade grade iron ores for steelmaking and to passivate the iron, and to integrate such indirectly heated reactors to both ironmaking and steelmaking.

### BACKGROUND

The iron and steel industry is responsible for about 6-8% of global CO₂ emissions, and there is a need for the steel industry to reduce its CO₂ emissions to mitigate global warming. The World Steel Association reported that in 2019, and the CO₂ emissions intensity was about 1,800 kg of CO₂ per tonne of steel and the energy intensity is about 19.84 GJ/tonne for the production of 1.1 billion tonnes of steel. Since 2010, the CO₂ emissions intensity has increased from 1,800 to 1,830 and the energy intensity has fallen slightly from 20.13 to 19.84 GJ/tonne. The steel processes generally include the ironmaking from iron ore and steelmaking steps, which may be closely integrated for steelmaking directly from iron ore.

It would be appreciated by a person skilled in the art that the prior art of iron and steel is vast and deep, and most of the patents relevant to processes used in these industries have been progressed through iterative improvements of processes adopted well over 30 years ago. Today, the energy intensity of the current processes is very high, and the high emissions intensity is a consequence of the development of these processing using processed coal for combustion, reduction, electrodes, and for incorporation in carbon steels. This the prior art is defined by particular technologies developed over a long time, rather than patents and publications.

There are three dominant ironmaking processes, namely sponge iron in which the gangue in the iron ore is not removed, and pig iron production in which the gangue is removed by slagging, smelt reduction.

There are three dominant steelmaking processes which may use this iron, or scrap steel, namely the Open Hearth Furnace, the Basic Oxygen Furnace (BOF) and the Electric Arc Furnace (EAF). Steel making is followed by casting, hot rolling and cold rolling processes. The BOF and EAF processes currently dominate the industry. There is a need to reduce the emission intensity of the production of steel for climate change mitigation. Most desirably the processes do not increase the overall energy intensity of the overall steelmaking processes, including sequestration costs of any captured CO₂. The inventions disclosed herein are primarily directed towards low emissions iron and steel production.

The reduction of the emissions intensity may occur initially through the substitution of iron ore by use of low emissions iron into the existing processes. The Open Hearth Furnace and the Basic Oxygen Furnace (BOF) may typically substitute up to 30% of DRI sponge iron. The BOF processes uses carbon, typically in the form of coke from metallurgical grade coal, for both the reduction of the iron ore, and the heating processes, and as the source for the carbon in carbon steel. The CO₂ generated in the steel making process is formed during the reduction of iron ore to molten iron. The CO₂ produced is present as part of the furnace off-gas known as Blast Furnace Gas (BFG) from the use of coal.

The transformation of existing BOF processes to make low emissions steel is generally limited to about 30% reduction of emissions using H-DRI as a feed. The substitution of coal by natural gas may also reduce the emissions intensity. The emissions may be reduced to about 600 kg CO₂/tonne. This is insufficient to meet the goal of mitigating climate change and achieving zero emission by 2050.

The substitution of scrap steel by DRI into the EAF processes may be up to 100%, but substitution is currently limited to DRI produced from high grade ores because the EAF is intolerant to large amounts of gangue from low grade ores. New EAF designs, such as the Submerged Arc Furnace (SAF) are being developed to overcome this limitation. To meet current market needs and to reduce emissions, it is preferable that low carbon DRI process are adopted to use low grade ores.

The production of carbon steel requires the addition of carbon to make sufficient cementite Fe₃C for strength. The reduction of emissions from cementite production is also required to lower the CO₂ emissions from steelmaking. Another source of CO₂ emissions in steelmaking is the emissions from the use of lime from limestone, and from other carbonates such as dolomite which is often used for optimising the Ca:Mg ratio for slagging. A further source of CO₂ emissions is from transport or iron ore. There are many sources of CO₂ emissions in the supply chain for steelmaking. However, the largest contribution to CO₂ emissions comes from the use of fossil fuels for the current DRI and BOF processes.

Over time new steelmaking process will be developed to make low emissions steel, driven by the need to reduce emissions to meet the zero emissions targets required to mitigate climate change. The invention disclosed herein is directed towards low emissions iron, for both iron and steel production.

The global supply of high-grade iron ores is reducing, so that any developments to reduce emissions intensity and maintain energy efficiency, should preferably enable the use of low-grade ores to make iron and steel. The invention disclosed herein may be adopted to beneficiate low-grade ores for both ironmaking and steelmaking.

The roadmaps to produce low emissions intensity steel are primarily based on the use of low-emissions power, and hydrogen gas for the iron reduction process. Also, roadmaps acknowledge the inevitable of low-grade iron ore due to the growing scarcity of high-grade iron ores. Of the steelmaking processes, there are fundamental reasons why the dominant BOF process, using coke, cannot be adapted to produce low emissions steel. The roadmaps exclude “end-of-pipe” processes, such a carbon capture and storage (CCS) for steelmaking or ironmaking because these processes have generally been found to be uneconomical for commodity products, such as steel. Thus, the principal means of production of low emissions iron and steel look towards a modification of the current DRI process to use low emissions hydrogen instead of mixed hydrogen and carbon monoxide, syngas, from natural gas to make sponge iron, in a process called H-DRI. The prospective route to low emissions production of steel from H-DRI from the sponge iron is to operate the EAF process using renewable power. It is often implied that means of beneficiation of low grade iron ores can be accomplished. There are a number of H-DRI processes that have been developed.

The prospective H-DRI processes may be categorised by two approaches:—

(a) Pellet Reduction. The first approach being developed for low emissions DRI process is to adapt successful DRI processes, such as the MIDREX (low pressure) and HYL (high pressure) processes. This pellet DRI process, uses a shaft furnace in which pellets of iron ore are slowly reduced to sponge iron pellets. This is a proven technology for DRI. Low emissions may be achieved using hydrogen instead of syngas as the reductant. Such a process is called H-DRI, and an example is the HYBRIT process in Sweden, https://www.hybritdevelopment.se/en/, in which hot H-DRI pellets are made from high grade ores for direct injected into an EAF process for steel. The process changes must take into account the transformation of the process from an exothermic reaction using syngas to an endothermic reaction using hydrogen.
(b) Particle Reduction. The second approach to H-DRI processes is to use particle flash reduction of particles, which has the benefit of eliminating the pelletization process used in (a).

One example of particle reduction is The Flash Iron Making Technology (FIT) has been developed at bench scale based on the use of a suspension reactor in which preheated iron ore powder, generally less than 30 microns, is entrained in a downwards co-flow of hydrogen and oxygen. The combustion of the hydrogen heats the powder to a sufficiently high temperature, typically above 1300° C., such that the reduction process is substantially complete in the residence time of about 5 seconds. The FIT process using a flash reactor is reported in “A Novel Flash Ironmaking Process” US DOE, Office of Energy Efficiency and Renewable Energy, 2018. The residence time is short because of a number of factors, namely the co-flow of the solids and gases in which the flow of particles is fast because of the entrainment in downflowing gas; the high temperature of the process gives a very high gas velocity; and the mixing of the combustion gas and the reducing gas streams further increases the gas velocities; and the production of steam by combustion drives the reaction to the high temperature because of the steam drives the back reaction. The net result of the high temperature and gas velocity is that the residence time of about 5 seconds may be achieved in a reactor which is about 19 m tall. While the FIT process temperature is below the melting point of iron, it is reported that there is strong sintering of the particles which closes the pores in the particles and increases the reaction time because the hydrogen gas is impeded from reaching the reduction reaction front in the particles.

Another example of particle reduction is the adoption of the HIsmelt process to hydrogen. The HISmelt process is a commercial EAF iron making process in which molten droplets of sponge iron produced by combustion of oxygen and syngas and syngas reduction are injected into a bath of molten steel. The molten sponge iron droplets are made from iron ore particles injected into a hot cyclone collector where the cyclone is developed from syngas combustion with oxygen to activate the reduction process with hydrogen and carbon monoxide and the temperature is sufficiently high that molten sponge iron is produced. In the molten bath the gangue is removed by slagging to make pig iron, or if the iron ore grade is high, the molten iron may be injected into an EAF. The HIsarna process replaces the syngas by hydrogen.

Another example of particle reduction is the FINEX process which uses fluidised beds, typically two three beds in series, to make iron by the heating of particles <70 μm is carried out by the combustion of syngas and oxygen, and reduction by excess syngas. The impact of agglomeration may be mitigated by modifying the process by changing the particle size distribution. The conversion of this fluidised beds approaches to hydrogen is being developed in a number of processes, such as HYFOR (<150 μm), CICORED (100-2,000 μm), and FINMET (50-8000 μm) technology, primarily distinguished by the different particle sizes as shown. It is noted that particles in range of <250 μm are commonly referred to as ultrafines.

In summary, all the approaches in the known art for H-DRI disclosed above use a oxygen for combustion for heating, and excess hydrogen for reduction within the reactor.

In an H-DRI processes, low emissions hydrogen, called blue hydrogen, may be made from fossil fuels to make hydrogen and carbon monoxide; steam is used to transform the carbon monoxide to CO₂ and hydrogen; the CO₂ gas is separated from hydrogen; the CO₂ is compressed to about 100 bar or liquified; and this CO₂ is transported and sequestered in geological reservoirs, where is transformed over a long period of time into carbonate rocks. Each of these process steps are proven technologies but they add costs to production.

Alternatively, low emissions hydrogen, called green hydrogen, may be made from renewable power sources such as solar, wind and hydropower using electrolysis of water. On the current trends green hydrogen will become the lowest cost because it is a simpler process and the cost of electrolysers is reducing, and the cost of renewable power from wind and solar are dropping. Green hydrogen is being progressed in the HYBRIT project.

The challenges of adaptations of processes that use fossil fuels are that the additional costs of production of hydrogen are generally not offset by process improvements. Also, many such processes are not adapted to the use of low-grade ores, such as are required for EAF use. The cost of pelletization of iron ores for processing in a shaft furnace is not insignificant requiring for example, the use of bentonite or biomass as a binder to inhibit breaking of the pellets in the bed of a shaft furnace.

It is noted that DRI processes can make hot sponge iron, which may be used in ironmaking to make sponge iron briquettes using the Hot Briquetted Iron (HBI) process. HBI processing is used to limit oxidation of the briquette, including inhibition of oxidation and spontaneous combustion during transport of the iron for steelmaking. HBI sponge iron is a product sold by ironmakers to steelmakers as a feedstock that can be fed into steelmaking processes. Thus HBI made using H-DRI any of the processes discussed above may be used to lower the emissions intensity for steel production. It is understood that H-DRI may be processed into briquettes of low emissions sponge iron using the HBI process.

HBI is not required if the H-DRI product is directly injected into molten iron for slagging to make pig iron ingots for use in BOF or EAF, or, in the case of high grade ores, injected directly into an EAF to make steel. Many particle based approaches for H-DRI considered above produce iron that may be directly injected into EAF steelmaking process provided a high grade iron ore is used to make the H-DRI.

It is noted that the EAF technology has been primarily developed for batch re-processing of scrap steel. There are developments of continuous EAF processes so that H-DRI pellets, briquettes or ingots may be processed to steel continuously.

As noted above, the use of hydrogen for reduction of iron ores turns the reduction process into an endothermic reaction, whereas with carbon-based fuels, the reaction is generally slightly exothermic. It is appreciated by persons skilled in the art that the hydrogen-based process described above for ironmaking and steelmaking, in their many forms appreciate that the production of hydrogen is energy intensive. There is a need to develop processes that minimise the consumption of hydrogen.

In this invention, it will be disclosed that indirectly heated reactors may be used for processing iron ore in hydrogen-carbon monoxide/syngas (a DRI Reactor) and may be preferably hydrogen (H-DRI Reactor). H-DRI lowers the CO₂ emissions intensity.

Indirectly heated reactors, have previously been described by Sceats et. al, for:—
(a) CO₂ reduction processes for calcination of carbonate materials by Sceats et. al, in WO2016/077863 “Process and Apparatus for Manufacture of Calcined Compounds for the Production of Calcined Products” and references therein, and in AU2020904492 and AU20201902810 “Process and Methods for the Calcination and Minerals” and references therein, WO2015/077818 “Process and Apparatus for Manufacture of Portland Cement” and WO2021 references therein.
(b) The processing of powders which exhibit phase changes in AU2020902858 “A Method for Pyroprocessing of Powers”, and references therein, and
(c) The processing of materials to make materials for use in batteries in AU2021902040 in “Processes and Methods of Calcination of Minerals”
where these inventions recognise that the indirect heating means that heat is generated externally from the reactor vessel and may either arise from combustion reactions in a furnace that surrounds the reactor, or use resistively or inductively heated electrical elements; and that heat transfer into the reactor may be carried out from such furnaces through steel or other thermally conducting elements to separate heating and processes.

This prior art on indirectly heated reactors does not disclose the use and benefits of using such indirect heating of reactors for ironmaking or steelmaking.

This prior art for indirect heating does disclose the manufacture of low emissions lime or dolime, which may be used to replace conventional lime or dolime, for a low emissions slagging process to remove gangue from ironmaking or steelmaking processes.

An object of the present invention may be to provide one or more means of optimising the design of indirectly heated reactors to make DRI iron, and preferably H-DRI iron.

Another object of the present invention may be to provide one of more means of using electrical power to provide the indirect heat to DRI or H-DRI Reactors

Another object of the present invention may be to describe of upgrading of low-grade iron ores using such indirectly heated DRI or H-DRI Reactors.

Another object of the present invention may be to describe a process for carburization of iron particles for the purpose of passivating the iron and providing carbon in the iron for the production of mild and carbon steels, thereby enabling carbon sequestration in carbon steel, particularly if the source of carbon is from CO2 that would otherwise be emitted. Mild steel comprises about 0.03-0.15% carbon and carbon steel comprises 0.3-1.5% by weight. It is noted that a process for carburation of iron using carbon monoxide CO has been disclosed in U.S. Pat. No. 5,869,018 by Stephens.

Another object of the present invention may be to provide a means of scaling up indirectly heated DRI or H-DRI Reactors to increase the production capacity.

Another object of the present invention may be to describe the integration of indirectly heated DRI or H-DRI Reactors into ironmaking processes.

Another object of the present invention may be to describe the integration of indirectly heated DRI or H-DRI Reactors into a steelmaking processes.

Any discussion of the prior art throughout the specification should in no way be considered as an admission that such prior art is widely known or forms part of common general knowledge in the field.

### SUMMARY

The inventions of this patent are generally associated with indirectly heated Direct Reduced Iron (DRI) and Hydrogen Direct Reduced Iron (H-DRI) Reactors for ironmaking and steelmaking using, respectively carbon monoxide/syngas or hydrogen as the reductant. The use of hydrogen is preferred to lower CO₂ emissions. Any references to an DRI Reactor with respect to the disclosed inventions includes a reference to an H-DRI Reactor as the context permits.

Such inventions include:—

(a) An indirectly heated DRI or H-DRI Reactor for reducing iron ore powder, which enables control of the reactor temperature profile along the reactor walls to initiate and sustain the reactions to sufficiently complete the reduction process within the residence time of the powder particles in the reactor.
(b) Such an indirectly heated DRI or H-DRI Reactors reactor is agnostic to the fuel for heating, and may be powered by indirect combustion of gases without the usual limitations of direct combustion in which the iron ore also reacts with the combustion gas and impurities therein.
(c) Such an indirectly heated DRI or H-DRI Reactor may use electrical power for heating, using resistance, induction or microwave heating. Such a reactor may be explicitly referred to as an indirectly heated e-DRI Reactor or e-H-DRI Reactor. It is preferable that such a reactor has a capability of either operating with a variable power throughput to enable fast shut-down and start-up to deal with the typical variable supply of renewable power and enable load balancing of a grid with a variable feed rate of inputs of iron ore and reducing gas, or operating at near constant power using energy storage systems, such as batteries, heated fluids or solids to provide heat or power when renewable power generation is low.
(d) The using a module of such indirectly heated DRI or H-DRI Reactors to scale up the process, while preferably allowing for control of each reactor by controlling the powder input, the reducing gas input, and any selected indirect heating input if required.
(e) The use of multistage indirectly heated DRI or H-DRI Reactors, and comminution if desired, to enable upgrading of the powder in terms of iron content, using magnetic separation of the gangue from partly processes iron powder before the final stage of reduction to a high-grade iron described above.
(f) The use of indirectly heated DRI or H-DRI Reactors segments to enable passivation of the iron surfaces by development of carbon coatings, to increase the resistance to oxidation and self-combustion, and to provide carbon for carbon steel and thereby enable sequestration of carbon in steel.
(g) The integration of such indirectly heated DRI or H-DRI Reactors with a furnace that melts the iron powder and mixing the molten iron with a slagging agent such as low emissions lime/dolime to produce ingots of high-grade pig iron.
(h) Means of integrating such indirectly heated DRI or H-DRI Reactors which consume high grade iron in the form of either briquettes or ingots with an EAF process, including the addition of fluxes, to make steel.

### Problems to be Solved

Control of Reactors by Indirect Heating. There is a need to provide improved control of reactors for the reduction of iron. The inventions described herein disclose that indirect heating of powders and gases in a DRI or H-DRI Reactor process provides improved control of the DRI or H-DRI process compared with the existing art for DRI or H-DRI processing for ironmaking and steelmaking, where combustion and reduction simultaneously take place within the reactor vessel.

Hydrogen Reduction. There is a need to reduce the amount of hydrogen used in an H-DRI process. The cost of producing green or blue hydrogen are high, so that an H-DRI process should preferably be developed which minimises the use of hydrogen. It will be shown that using indirect heating lowers the demand for hydrogen and oxygen. The paradigm developed in this disclosure is that hydrogen should be used for iron reduction, and indirect heating can be provided from either low-cost combustion or preferably electrical heating. Such a cost reduction may offset the energy required to grind run-of-mine iron ore to a powder size for processing in such an indirectly heated reactor.

Processing Iron Ore Fines. There is a need for an iron ore reduction process which can be used to processing of iron ore fines, preferably to less than about 200 μm. Such fines are produced at many stages from mining to iron making and steelmaking, and provide a convenient source of powder that cannot be readily processed in shaft furnace or fluidised beds.

Processing Low Grade Iron Ore. There is a need to develop iron processing which can use low grade iron ore as a feedstock, and to upgrade the quality of iron by removing gangue to be used in steelmaking. The disclosures of this invention include a number of processes for such beneficiation of iron ore using indirectly heated DRI or H-DRI Reactors.

Carbon Sequestration in Steel. There is a need to add carbon to iron to manufacture mild carbon steels. The disclosures of this invention include processes to carburize, or partially carburize DRI or H-DRI during the manufacture of iron, in a process that enables carbon sequestering in steel.

Reactor Scale-Up. There is a need for indirectly heated DRI or H-DRI Reactors to be scaled up for processing large volumes of iron ore.

In summary the disclosures of this invention are directed to the use of indirectly heated DRI or H-DRI Reactors which may use any means for indirect heating and reduction gases, which may also uses the benefits of reactor control, high thermal efficiency, processing iron ore fines, upgrading low grade iron ores, carburizing and passivation of iron with carbon, and a means to scale up using modules of such reactors.

CO₂ Emissions Reduction. The overarching objective of this invention is to reduce the emissions of CO₂ for the production of iron or steel in which an H-DRI Reactor uses renewable power for heating and green hydrogen with benefits described above, and zero emissions lime and dolime for slagging, and additionally using carburization of iron for carbon sequestration.

### Means for Solving the Problems

It is accepted that indirectly heated reactors, such as drop tubes, have been used for laboratory evaluations of materials. However the prior art a Sceats et. al. has demonstrated that indirectly heated reactors can be deployed at industrial scale for a variety of applications.

The present invention relate to the industrial application of indirect heating to DRI and H-DRI Reactors, including the use of electric power heating for e-DRI and e-H-DRI Reactors, called herein the e-DRI and e-H-DRI Reactor.

According to a first aspect, the invention provides an externally heated vertical reactor for reduction of iron ore, the reactor comprising:
(a) a reactor tube positioned vertically adjacent to a furnace, wherein an input powder of iron ore is injected into a hopper adjacent to a top end of the reactor tube and the input powder falls downward through the reactor tube; wherein an input of reducing gases is injected at a base of the reactor tube;
(b) an external furnace positioned vertically adjacent at least one wall of the reactor tube to provide heat to be conducted through the at least one wall wherein the conducted heat raises a temperature of the falling input powder;
(c) an input port at a base of the reactor tube, wherein the reducing gases are heated and injected into the input port such that the reducing gases rise upward through the reactor tube to further raise the temperature of the falling input powder such that the iron ore is reduced by the rising reducing gases, wherein a reaction temperature of between 700° C. and 900° C. is reached such that the reducing gases are consumed by the iron ore in a reduction reaction which results in the formation of a reduced iron powder product at the reactor base; wherein external heat is controlled along a length of the reactor tube to maintain a reaction temperature profile to reduce the iron ore.
(d) a gas exhaust positioned adjacent a top surface of the reactor wherein gas exhausted at a top of the reactor forms a stream and entrains unreacted input powder particles, wherein the unreacted particles are extracted from the gas stream and reinjected into the reactor;
(e) a gas filter positioned adjacent an entrance to the gas exhaust wherein gas extracted from the reactor tube scrubbed of gas reaction products comprising steam and carbon dioxide, and the scrubbed extracted gas is reinjected into the input gas stream; and
(f) a bed positioned at the base of the reactor tube, wherein the reduced iron powder product is collected in the bed at the base of the reactor tube and exhausted from reactor for subsequent processing.

The reducing gases preferably comprise carbon monoxide, hydrogen, methane or mixtures thereof.

An external heat source is created in the furnace from combustion of a solid or gaseous fuel, or generated from electric power using resistive, induction or microwave generation and distributed along the length of the reactor to provide a reactor wall temperature profile wherein the volume fraction for a radiation penetration depth of about a metre is about 1×10−4 when wall, gas and particle emissions are accounted for, and wherein the reactor walls are heated to temperatures between 1100 and 1700° C.

The iron ore powder may be hematite, magnetite, gothite, siderite or other iron based minerals, and mixtures thereof that require reduction of iron for processing the minerals.

At least one wall of the reactor tube is preferably made from steel or ceramic, which is stable to hydrogen at about 1050° C.

Preferably, the reducing gas is hydrogen, and the source of heat is renewable power so as to minimise CO2 emissions intensity of the product.

The input powder preferably has a range of particle diameters of greater than 25 μm and less than about 250 μm. A diameter of the reactor tube is preferably no larger than about 2 m, and a length of the reactor tube is between 10 to 35 m. wherein a residence time of the downflowing iron ore particles is about 10 to 50 seconds, wherein the residence time is dependent on a gas flow direction and cluster formation of the iron ore particles.

A heat exchange between walls of the reactor is preferably less than about 100 kW/m.

An average velocity of the input powder during the fall through the reactor tube is preferably less than 3.0 m/s and greater than 0.2 m/s. Preferably, a flux of the input powder in the reactor is in the range of 0.5-1.0 kg m-2 s-1.

The input powder and input reducing gases are preferably preheated from waste heat from other processes such as a water condenser and other processes associated with a use of the reduced iron product.

The unreacted input powder particles extracted from the gas stream are preferably reinjected into the reactor tube through a metal tube passing through a centre of the reactor tube with hydrogen so that these particles are heated and reduced during their transit to the base of the reactor.

The degree of reduction of iron is preferably 95% or more.

According to a second aspect, the invention provides a process of reducing input iron ore powder using the externally heated vertical reactor according to the invention wherein an input iron ore powder is low grade hematite or gothite, wherein
(a) the process is controlled to substantially limit the degree of reduction to produce a ferromagnetic material such as magnetite; and
(b) the powder cooling process, is a flash quenching process; and
(c) used
(d) a magnetic separator is used to separate gangue from a magnetic iron ore product; and
(e) the magnetic iron ore product is injected into a second reactor according to any one of claims 1 to 15 to be processed to iron.

According to a third aspect, the invention provides a process of reducing input iron ore powder using the reactor according to the invention wherein (a) low grade iron ore particles are processed into a hot iron powder; and

(b) the hot iron powder is injected into a heated vat to produce molten iron; and (c) the molten iron and a slagging agent such as lime are mixed in the heated vat such that slag is formed, wherein the slag floats to the top of the vat, and is discharged and cooled; and (d) the molten iron is tapped from the heated vat and cooled and processed to make ingots of high-grade iron.

According to a fourth aspect, the invention provides a process to activate impervious iron ores wherein:
(a) an iron ore is oxidised to make a porous hematite ore;
(b) the porous hematite ore is reduced in an externally heated vertical reactor according to the invention to make iron ore. Preferably, the oxidation process uses an externally heated vertical reactor according to the invention in which the reducing gas is replaced by air.

According to a fifth aspect, the invention provides a process of producing cementite wherein
(a) an iron ore is reduced using an externally heated vertical reactor according to the invention to make iron particles; and
(b) if required, the process of the fourth aspect may be incorporated to produce a high-grade iron powder, and
(c) the iron powder may be use as a feed into an externally heated vertical reactor according to any one of claims 1 to 15 in which CO₂ and H₂ are used as the gaseous feed, and
(d) the reactor temperature and the relative composition fraction of CO₂ and is selected to transform a fraction of the iron to cementite.

According to a sixth aspect, the invention provides an externally heated vertical reactor according to the invention used to beneficiate iron, activate impervious iron ore, or producing a desired fraction of cementite in iron, by using a module, of about 8 such reactors in which an input iron ore feed is distributed to the reactors from a central silo, the reducing gas is distributed to the reactors from an appropriate gas source, and heat may be exchanged independently from other elements of the industrial process to heat up power or gas.

In a further aspect of the present invention, there is disclosed a means of using indirectly heated DRI or H-DRI Reactors for reducing iron ore. This aspect includes the preferred means of using hydrogen for reduction and renewable electrical power for indirect heating, which together reduce emissions intensity to almost zero, as the e-H-DRI reactor.

In another aspect of the present invention, the means of beneficiation of low-grade iron ore are disclosed using configurations of indirectly heated DRI or H-DRI Reactors.

In a further aspect of the present invention, the means of sequestering CO₂ in iron for the production of carbon steel and passivating iron.

In another aspect of the present invention, there is disclosed a means of scaling the process of the first aspect using a module of a number of such indirectly heated DRI or H-DRI reactors for ironmaking and steelmaking.

Further forms of the invention will be apparent from the description and drawings.

### BRIEF DESCRIPTION OF THE FIGURES

Embodiments of the invention will be better understood and readily apparent to a person of ordinary skill in the art from the following written description, by way of example only, and in conjunction with the drawings, in which:

FIG. 1 is a schematic of an example embodiment of an indirectly heated DRI reactor operating at commercial scale. In this example, the indirect heating is a combustion furnace system using any fuel, and the reducing gas in the reactor is CO, H₂ or a mixture, such as Syngas. FIG. 2 is a schematic of an example embodiment of an indirectly heated DRI reactor in which the indirect heat is provided by electrical power and hydrogen gas is used as the reducing gas (the e-H-DRI Reactor). The embodiment of FIG. 2 may achieve near zero emissions when renewable power is used.

FIG. 3 is a schematic process flow for upgrading low grade iron ore using a segmented indirectly heated DRI or H-DRI Reactor in which a first segment is used to make a magnetic iron material to enable magnetic separation of gangue, and a second segment is used to complete the reduction to iron.

FIG. 4 is a schematic process flow for upgrading low grade iron ore in which the iron powder from an indirectly heated DRI or H-DRI Reactor to make a DRI powder which in injected into a vat of molten iron in which a slagging agent is injected to extract gangue, and then to produce ingots of pig iron.

FIG. 5 is a schematic process flow for passivating iron ore with cementite and providing carbon for mild steel and carbon steel production using a segmented indirectly heated DRI or HDI-Reactor in which DRI is produced in a first segment and the coating of the iron is generated by injecting a gas of CO₂ and Hydrogen to deposit a layer of cementite Fe₃C. The CO₂ may be used to sequester carbon in steel and lower the CO₂ footprint of the steel.

FIG. 6 is a schematic process flow in which in which the iron powder from a module of indirectly heated DRI or H-DRI reactor is used to make a DRI powder which in injected into a vat of molten iron in which a slagging agent, such as lime, is injected to extract gangue and to produce ingots of pig iron for steelmaking.

### DESCRIPTION OF THE INVENTION

Preferred embodiments of the invention will now be described by reference to the accompanying drawings and non-limiting examples.

### Indirectly Heated DRI and H-DRI Reactors

In the production of iron and steel using the known art of DRI processing, and the published art described from trials to develop H-DRI processing, the reducing gas always plays two roles. The first role is combustion with injected oxygen to provide the heat to raise the temperature of the gas and solids to initiate the reduction reaction, and to supply additional heat, as required, for the reduction of iron ore to iron by hydrogen; and the second role is to provide the gas for reduction. In some cases, the combustion/reduction processes include coal as the fuel.

The current DRI processes have been developed for ironmaking and steelmaking processes, and those that are the most commercially developed use pellets or fine/lump iron ore as the feedstock. In these DRI reactors, slowly moving beds of pellets are reduced by reducing gases in a shaft kiln. Heat from combustion is adsorbed at the surface of pellets, and the diffusion of heat and reduction gases through the pellets are generally the rate limiting process for the reduction reactions. Typical residence times in such packed beds to achieve uniform reduction is the order of hours.

The primary disclosure of this invention is that heating may be delivered to the reactants from indirectly heated walls of a reactor, rather than from combustion within the reactor. However, the penetration of heat from a heated reactor surface into a moving packed bed is confined to the region near the hot surface, and the resulting temperature gradient is so high that indirect heating is not useful for a packed bed reactor. To make such a DRI of H-DRI Reactor the iron ores should be injected as particles with a particle size distribution is less than about 250 μm should be used and the volumetric-solids-fraction of particles is the order of about 10⁻⁴ to achieve uniform reduction across the reactor.

This low volumetric-solids-fraction is such that the penetration depth of radiation is ideally equivalent to the reactor tube radius of the invention of about 1 m so that the temperature distribution across the reactor is preferably near uniform. It has been found, in the prior art of Sceats et. al, that many chemical and physical reactions are sufficiently fast in such small particles because heat and mass transport in particles is fast enough that the increase in the rate of reaction from use small particles compared to pellets offsets the lower volume fraction. Thus the flux of products is similar to that of packed bed of pellets with combustion gas in the reactor, or a fluidised bed of particles. The residence time of powder particles in an indirectly heated reactor is preferably less than about 50 s. The fast reaction time is such that the mass flow of iron ore in an indirectly heated reactor of small particles flowing in a reactor is similar to the moving beds of pellets used in conventional DRI reactors, so the flux of products through the reactor cross-section is similar.

The indirect heating of a falling stream of particles is compared to a fluidised bed where the benefit of indirect heating is that the propensity of the bed to collapse from fluctuations is removed, which specifically makes fluidised beds very susceptible to particle agglomeration. It is accepted that an indirectly heated reactor may be taller than a fluidised bed for equivalent heat transfer. When the indirectly heated reactor operates with a falling powder and a rising gas, there is the same propensity of fine particles to be elutriated from the reactor, which is overcome by reinjection of such particles into the reactor as used for circulating fluidised beds. The advantage of indirectly heated reactors is that the gas flow rate is reduced by the absence of rising combustion gas, and the degree of elutriation is therefore smaller.

The premise of the inventions disclosed herein is that flux of iron from an indirectly heated reactor with a reducing gas is similar to the reduction of a packed bed of iron ore pellets or a fluidised bed of particles where direct heating is used from combustion of a portion of the reducing gas within the reactor. This approach has been verified by processing a wide range of iron ores in an indirectly heated reactor.

In respect of energy efficiency the radiation of heat into the reactor from the indirect furnace is offset by some radiation loss from the loss heat to the external walls of the furnace to ambient air. This is minimised by using refractories to surround the external surfaces of the furnace. A thick refractory stores energy, which may cause a delay in response of the system to a change in temperature of the heater. In some applications, there is a need for a fast response so that low thermal mass refractories may be used. Thus indirectly heated DRI and H-DRI reactors have a comparable energy efficiency to existing processes.

The benefit is that these reactors provide more flexible operation for dealing with variations of either heat, iron ore powder, or reducing gas mass flow rates, and the heating energy may be produced by any combustion process, and electrical power or combinations thereof.

Consider the first aspect of this invention. A means of using an indirectly heated DRI or H-DRI Reactor are disclosed for reducing iron ore at industrial scale. It is a fundamental principle of iron ore reduction that the iron ore must be heated to initiate the reduction reaction in reducing gases such as carbon monoxide or hydrogen. The prior art heats the iron oxide by injection of oxygen into the reducing gases of H₂ and CO to induce combustion of reducing gases to provide the heat. At a certain temperature, which is set by the iron ore properties, the iron ore reduction processes with excess CO and H₂ commence. The reduction of iron ore by CO is exothermic, and with H₂ it is endothermic, so that a balance can be achieved by control of the gas composition. Generally, a consequence of combining an oxidising combustion process, and a reduction process in the same reactor places constraints on the control of the process. This is compounded by a need to introduce the iron ore as pellets to limit the exhaust of fines in exhaust the gas stream, or complex fluidised beds. The iron and steel industries have developed, over many years, energy efficient means of operating this process, and scaling up of the process in large reactors, such as the BOF.

The use of indirect heating of the iron ore eliminates the need for carrying out the combustion process within the reactor to provide the heat. The transfer of heat from the combustion in an external furnace is through a thermally conducting medium, such as steel or ceramic walls. The control of the process is enhanced by the ability to control the temperature distribution along the reactor, whereas in a conventional process, this would require injection of reducing gas or oxygen at various point along the reactor.

One consequence of indirect heating is that reduction process is independent of the source of heat, so that low grade fuels may be used for combustion in an external furnace that contain materials that would adversely impact on the quality of iron if used in the internal combustion-reduction process. Another consequence is that air may be used for fuel combustion rather than expensive oxyfuel combustors.

Ideally, the particle size in an indirectly heated reactor should be less than 250 μm, which can be achieved by crushing and grinding the ores, and the preferred bound of 250 μm can be readily achieved using at low-cost crushers and grinders of the run-of-mine iron ore. Preferably, the fraction of particles less than about 25 μm should be small, and may be reduced during grinding by mechanofusion.

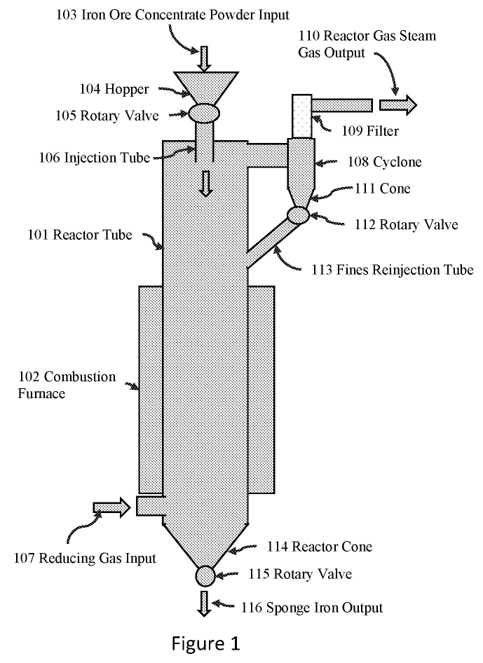

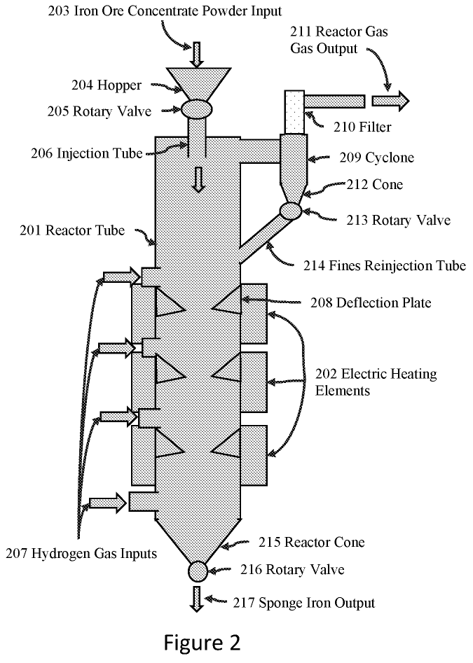

In FIG. 1, a schematic is shown for an indirectly heated DRI or H-DRI reactor for production of sponge iron powder from an iron ore powder injected from the top of the reactor and a reducing gas injected at the base to provide a counterflow of gas. The reducing gas may be a CO, or H₂ or a mixture thereof. The reactor primarily comprises of reactor tube 101 and a combustion furnace 102, which may be powered by a gas, or gas-solids combustion process. The iron ore concentrate powder input 103, preferably dried and preheated, is injected into a hopper 104 to form a bed of powder which is injected at the top of the reactor by a rotary valve 105 into an injection tube 106 to form a downward plume of powder. At the base of the reactor a stream of reducing gas 107 is injected tangentially into the reactor at a pressure of about 105 kPa as a swirl. The gas may be preferably preheated. The rising gas and the falling powder is heated by the external combustion furnace through the reactor walls. Segmented combustors can provide the desired reaction temperature along the reactor so that the reducing gas is consumed at a controlled rate by the iron ore in this configuration. This is important because the reactions may be endothermic, exothermic, or a mixture of both depending on the reducing gas composition and the reduction kinetics at any point in the reactor. Through the reduction process the reducing gas is transformed to steam and CO₂ as the gas rises through the reactor. As noted above, the reducing gas injected into the reactor is in excess of the amount consumed so that the reduction reactions can proceed to completion. At the top of reactor the exhaust gas steam is exhausted from the top of the reactor and carries powder fines, which are separated from the gas by a cyclone 108 and a filter 109 to give an exhaust gas steam 110. The exhaust gas is cooled by the falling powder. The gas is cooled by the falling powder. Entrained fines are collected into a bed in the cone 111, and are reinjected into the reactor using a rotary valve 112 through the fines reinjection tube 113. All the processed powder, as sponge iron is cooled by the gas injected at the base of the reactor and is collected in the cone 114 at the base of the reactor in a bed and is released from the reactor through a rotary valve 115 as sponge iron 116. The exhaust gas steam 110, containing typically steam, CO₂ and unreacted reducing gas is cooled and the water and CO₂ are extracted using known processes used in the petrochemical industries. The excess reducing gas is recycled into the reactor as part of the reducing gas stream 107. The desired process temperature should preferably be low so that the reaction rate is not inhibited by either sintering of the surface area of the particle or melting of the iron which slows the diffusion of hydrogen to the oxide. The residence time in the reactor is preferably less than 50 s and is typically in the range of 10-50 s. The extent of preheating of powder and gases may be determined by minimising energy losses from an integrated system, and also determined by the process requirements to inhibit undesirable reactions.

The fast-processing time of the reactor is such that the amount of material in the reactor is the order of 10 s of kilograms so that a iron feed ore and reducing gas feed rate rate can be changed very quickly to meet the energy available from heat production.

Thus the invention of this disclosure is to directly heat iron ore particles flowing down are reactor in a dilute flow regime where the volume fraction of particles is sufficiently small that the radiation from the reactor walls can penetrate though the dust of the powder and the gas. The radiation penetration depth of the order of a meter, and the volumetric-solids-fraction is about 104 when wall, gas and particle emissivities are accounted for at temperatures of the order of 700-1100° C. The need for a low solids-volume-fraction of particles in a powder means that the residence time of the particles in a reactor height of 8-30 m is the order of 10-50 seconds for downflowing particles in a counterflow of reducing gas. Thus a primary consideration is the reaction rate for reduction of iron, so that the reaction can go to completion in the residence time required.

The short residence time considered above has certain benefits. Iron, once formed at the process temperature of interest, can diffuse quickly through the particles and is known to form “hairs” of iron which cause agglomeration of iron particles. This is a known risk which causes challenges in fluidised bed reactor because agglomeration or “sticking phenomena” that can case the bed to collapse, so the reactor ceases to operate and the time to re-establish the flow conditions is too long for commercial operations. The inventions disclosed herein describe a process which is not a fluidised bed.

From the consideration of the above, the criterion for application is whether iron ore particles can be processed to sponge iron within about 10-50 seconds. For reasons considered below, the process temperature should be preferably in the range of 700-900° C. This low temperature prevents “sticking phenomena” which is common in gas-based DRI reactors such as fluidised beds. The kinetics of reduction of iron ore has been studied intensively. It is known that the kinetics of direct reduction reactions of hematite to magnetite, and magnetite to wüstite occur very quickly, compared to the slow reduction of wüstite to iron, which is then a rate determining step. The definitive study by Liu et. al in W. Liu, j. Y. Lim, M. A. Sausedo, A. N. Hayhurst, S. A. Scott and J. S. Dennis, “Kinetics of the reduction of wüstite by hydrogen and carbon dioxide for the chemical looping production of hydrogen”, Chem. Eng. Sci. 120, 149-166 (2014) considers that the reduction kinetics. The work shows that even in about 5% hydrogen, reaction in this temperature regime is very fast, and the results, when extrapolated to 100% hydrogen initially at the base to about 60% hydrogen at the top of the reactor to ensure that the reaction is complete within less than 5-10 seconds for particle up to about 250 μm. This the rate of the reaction is sufficiently fast to be used in a dilute flow reactor which processes iron ore particles in hydrogen. More detailed calculation show that the heat exchange between the hotter walls of the reactor is less than about 100 kW/m, which is smaller than the rates of about 200 kW/m required for highly endothermic reactions. It may be concluded that neither the chemical kinetics of reduction nor heat transfer from the hot reactor walls is a limit the process described herein. Experiments conducted in indirectly heated reactors confirm these conclusions.

The requirement considered above limits the reactor to tubes that are up to about several metres in dimeter. The very fast reaction rate of seconds is such that the flux of sponge iron exhausted from the tube is terms of the cross-section of the tube is similar to the flux of a typical DRI reactor using a moving bed of pellets because the reaction rate in such a bed is the order of hours. It would be understood by person skilled in the art that a dilute flow of powder at velocities less that about 3 ms⁻¹ create much lower wear on the reactor materials than a moving bed of pellets. It will be apparent to a person skilled in the art that an indirectly heated DRI or H-DRI plant has the benefit of simplifying the production process of iron and steel by removing the need for pelletizing plants. In order to change from high carbon emissions production processes of iron and steel, it is important that costs can be reduced by eliminating manufacturing processes, such as pelletization. The ability to make iron or steel from iron ore concentrate has many such benefits.

The example of FIG. 1 is an indirectly heated DRI or H-DRI Reactor which does not explicitly address the need to reduce CO₂ emissions in the production of iron. Emissions reduction in the furnace may be accomplished by use of hydrogen as the injected reducing gas, or a low emissions fuel, such as biomass or waste. However, for large industrial plants, the availability of large amounts of biomass or waste is generally not available. An alternative approach which simplifies the heating process, is to use renewable electrical power for heating. This is considered below.

In FIG. 2, a schematic is shown for the preferable embodiment of indirectly heated e-H-DRI reactor for production of sponge iron powder from iron ore powder using hydrogen as a reducing gas. The reducing gas is H₂. The reactor primarily comprises of reactor tube 201 and an array of electric furnace elements 202. The iron ore concentrate powder input 203, preferably dried and preheated, is injected into a hopper 204 to form a bed of powder which is injected at the top of the reactor by a rotary valve 205 into an injection tube 206 to form a downward plume of powder. Along the reactor, streams 207 of hydrogen are injected tangentially into the reactor as swirls at a pressure of about 105 kPa. In this embodiment the electric furnace has a number of such injector elements 202 which can also preheat hydrogen for injection into the reactor, in combination with deflector plates 208 that deflect gas and particles. The turbulence can assist the break-up of gas and particle flows to inhibit formation of agglomerates of powders, enhance gas-particle heat exchange and increase residence time. The rising gas and the falling powder are heated by the electric furnace through the reactor walls such that the desired reaction temperature is reached so that the reducing gas is consumed by the iron ore in the reduction processes, which result in the formation of sponge iron at the reactor base. Through the reduction process the hydrogen gas is transformed to steam as the gas rises through the reactor. As noted above, the hydrogen gas is in always excess of the amount consumed so that the reduction reactions can proceed to completion. At the top of reactor the gas stream is exhausted from the top of the reactor and carries powder fines, which are separated from the gas by a cyclone 209 and a filter 210 to give an exhaust gas steam 211. The fines are collected into a bed in the cone 212, and are reinjected into the reactor using a rotary valve 213 through the fines reinjection tube 214. All the processed powder, as sponge iron is collected in the cone 215 at the base of the reactor in a bed and is released from the reactor through a rotary valve 216 to release hot sponge iron 217. The exhaust gas steam 211, of steam and hydrogen is cooled and the water readily extracted by cooling to form liquid water leaving a gas of hydrogen with minimal steam. The excess hydrogen is recycled into the reactor as part of the reducing gas streams 207. The desired reactor temperature should preferably be low so that the reaction rate is not inhibited by either sintering of the surface area or melting of the iron. The extent of preheating of powder and gases may be determined by minimising energy losses from an integrated system, and also determined by the process requirements to inhibit undesirable reactions.

The use of injection of gas flow and plate deflectors along the reactor may be used in any application of indirectly heated reactors. It is well established that counterflow gas and powder flows will organise in reactor tube to minimise the interaction so that down flowing particles tend to accumulate near the walls and the gas moves upwards with a high velocity in the middle of the tube. This means that the benefits of the rising gas to lower the velocity of the powder to increase the residence time and enhance the gas to particle heat transfer is lost. At the top of the reactor such separation can reduce the entrainment of fines in the exhaust and is useful. Particle and gas may be deflected by plates in the tube, but plates can be fouled. Simple approaches, such as an inner tube can break the symmetry to create an annular reactor and the tube can be used to inject gases in a different manner than described in FIG. 2. The injection of hydrogen does not deflect the particles significantly because the momentum of the hydrogen is small. The most desirable approach is to use deflector plates that are cleaned by hydrogen jets to prevent fouling of the plates as illustrated in FIG. 2. Pulsed gas systems are routinely used in filter systems, and may be used for this purpose. The spacing between such devices should be less than the length that would re-establish the steady state flows in a pipe. The details depend on the process details.

The use of electric powered elements as in the embodiment of FIG. 2 is such that very fast turn down or start up may be achieved. This reactor is designed to use renewable power, and such power is not constantly generated. At peak conditions of sun or wind, the cost is very low. This enables a reactor throughput to be turned up or down to meet the availability and cost of power, and of green hydrogen will have a similar response.

One approach is moderate the variable energy is to use reactor designs that a can switch between combustion or renewable power, or a variable mix of each.

Another approach is to store electricity in batteries, or store heat and convert heat to power, as required to maintain the required power over a period of time, and especially to fill gaps in renewable power from solar and wind plants. In the longer term, the average cost of renewable electric power, on a MWhr basis, is expected to fall below the cost of fossil fuels, so that electric power can be used for 24/7 operations to heat the reactor and generate hydrogen by electrolysis. In that case, it is always advantageous to use power for electric heating instead of using electrolysis to make hydrogen for combustion to generate heat by combustion.

In FIGS. 1 and 2 The heat wall for heat transfer may be either:—

(a) The metal alloy of steel which has negligible carbon that can be lead to attack by hydrogen, which leads in carbon steel to embrittlement and failure, and is a steel which has demonstrated strength at a temperature of about 1100° C. so that it can support its own weight as a vertical reactor tube, and may preferably be an alloy with nickel and chromium with addition a silica, where under appropriate conditions the steel forms a passivating layer of chromium and silica oxide. It is noted that the presence of a small amount of steam in the reactor is such that these oxide layers are stable in hydrogen. Further, the alloy should be an austenitic phase which inhibits the diffusion of hydrogen. When such a metal is used for heat transfer, the electrical elements are deployed in the furnace to irradiate the steel, and the quiescent gas conditions are such that an oxidising environment is maintained. Such a system may be ramped quickly with temperature, and the steel tube is mounted such that it may be replaced easily, using a bellow and a counterweight to reduce the stresses on the steel and to cope with thermal expansion and creep, and the gas pressure inside the reactor required to be maintained at a positive gauge pressure to inhibit buckling.
(b) A ceramic material may be used in the reactor design where an additional benefit is the ability to encapsulate the electrical heating element. Such elements maybe subject to thermal shock so that the operations of the reactor would take this into account.

FIG. 1 describes embodiments that use indirect heating from combustion while FIG. 2 describes embodiments that use indirect heating using electrical power. It is noted that the indirectly heated reactors, and in particular the indirectly heated H-DRI Reactors, described above may be applied to the processing of a wide range ferrous or ferric ores that contain elements such as manganese, nickel, copper, chromium and the like where an initial iron reduction step is required. The subsequent processes may include hydrometallurgical extraction processes or deeper reduction processes such as aluminothermic reduction. The advantage of the indirectly heated reactors described herein is that the products from this initial reduction step are powers which are generally used for floatation and acid-base extraction processes, and porous, allowing efficient extraction.

Another embodiment for DRI or HDRI processing is to modify the reinjection of the fines from the filter into the reactor. FIGS. 1 and 2 inject these particles into the top of the reactor with the input particle stream, so there is the potential for an overload of the fines in the cylone and filters. Alternatively, the fines may be injected into a central thermally conducting tube in the reactor with a some reducing gas in a coflow configuration. As the gas and particles flow down through the reactor, they are heated by the radiation/convection from the tube walls which are heated from the radiation from the reactor walls, and the reaction will take place as the conditions for reduction are met. The mass flows of the fines and particles are set so these particles are sufficiently reduced by the time that that the gas and fines are ejected near the base of the reactor. The fines are ejected towards the cone for the products, and the heated gas is directed to up into the reactor with the injected reducing gas, which may be preheated externally. The preferable configuration to accomplish this is a cyclone separator at the base of the reactor. It follows that the load of fines ejected into the top cyclone and filter may be substantially reduced by implementing this embodiment.

### CO₂ Emissions Reduction

The paradigm for the inventions described herein to reduce CO₂ emissions in the production of iron and steel may be based on indirect heating. A near zero emissions intensity can be achieved by using:—
(a) Iron ore fines with a particle size of preferably less than about 250 μm; and
(b) Green hydrogen or Blue Hydrogen with CCS for direct deduction of iron ore to iron; and
(c) Renewable electrical power should be used for indirect heating of the reactants and products to initiate the reduction reaction, and to provide the energy to drive the endothermic hydrogen reduction of iron ore to iron.

Because indirect heating is agnostic to the heating source, there are many ways of configurating the reactors between the embodiments of FIG. 1 (combustion heating) and FIG. 2 (electrical heating) to achieve a desirable degree of emissions reduction as

### Beneficiation Iron Ores and Using Indirectly Heated DRI or H-DRI Reactors

The beneficiation of low-grade iron ores may be accomplished by grinding the low iron ore to small particles and extracting gangue by a variety of processes based on known arts that use density difference between iron ore and gauge, or in the case of magnetite by using magnetic separators. In this section, iron ore beneficiation processes are described which include the use of indirectly heated DRI or H-DRI Reactors.

It is well established that reduction roasting of low-grade hematite ores can be used to enhance the magnetic separation of gangue from the magnetite produced by roasting, because the magnesite is a ferromagnetic material with a high susceptibility. Therefore the reduction of hematite to magnetite allows improved separation of gangue. Because the magnetic properties of iron ores depend on the thermal history through grain morphology, and particle size the detail process flows for beneficiation vary widely. Traditional magnetic reduction roasting is carried our over the timescale of hours. Given that the particle size for particle reduction is less than about 250 μm, the roasting time is very short and is the order of seconds, and the temperature is kept below the reduction temperature of magnetite to wustite, and a temperature of about 600° C. is chosen for flash roasting. As the product is cooled by flash quenching, preferably in an inert atmosphere to inhibit reoxidation, the Curie Temperature is reached and the magnetic susceptibility increases as the temperature is lowered. Flash quenching can cause strains in the powder particles, so that a further grinding step of the mote porous magnetite can release additional gangue.

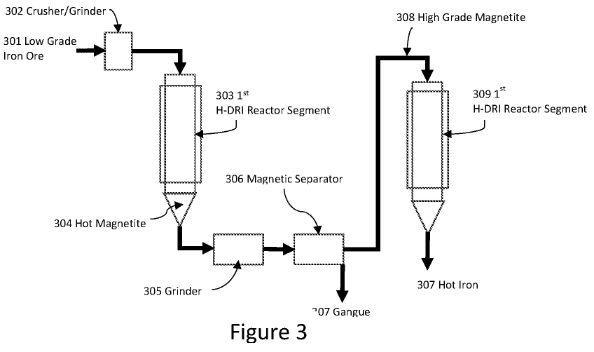

FIG. 3 shows a schematic process flow for upgrading low grade hematite ore 301 is ground by a crushed/grinder 302 to a size for injection into the first segment 303 of an indirectly heated H-DRI Reactor in which is operated to make hot magnetite 304 powder using hydrogen as the reductant, which reduces the hematite to magnetite which is flash cooled in nitrogen (not shown) and injected into a second grinder 305 to release gangue and the magnetite, and this powder is injected into a magnetic separator 306 to release a steam of gangue 307 and a stream of high grade porous magnetite 308. The porous magnetite ore is reduced in a second H-DRI segment 309 to 310 to produce high grade hot iron 311. The initial size for the crushing grinding circuit may be larger than the <250 μm specified for iron production, because the hematite to magnetite reduction process is very fast compared to the overall reduction to iron. Thus the process described in FIG. 3 may be iterated to release gangue is comminution stages.

The energy demand for the hematite to magnetite transformation is low, and energy can be recovered using standard heat recovery systems if required. The reactors may be an indirectly heated DRI reactor, offsetting the benefit of CO₂ emissions reduction when hydrogen is used instead of syngas. The energy consumption of the hematite to magnetite reaction is low, so the primary benefit of using the indirectly heated reactor is the fine control of the process, primarily to ensure that the sintering of the magnetite is minimised, and especially to inhibit any thermal reactions of the iron with gangue to form inseparable iron silicates. The flash quenching is desirable to increase the stresses in the cooled magnetite particle to facilitate particle decrepitation and release of gangue during the grinding of the magnetite. It is recognised that the process will separate out gangue particles materials that were either in hematite ore or released in the initial crushing/grinding step. The gangue stream may contain magnetite that was insufficient to be magnetically separated, and this feed can be further processed to remove such residual iron, including multiple passes through the magnetic separation processes described in FIG. 3. The process of comminution and thermal processing as described in FIG. 3 can be repeated until the required grade of the ore is achieved.

Hematite was selected as the iron ore to be processed in the two-stage reactor system described in FIG. 3 because it is generally a low grade iron ore, but other ores may be processed such as goethite and siderite.

Magnetite ores are found in nature, and are generally found as non-porous minerals, often associated with geological processes. As for hematite, high grade magnetite ores are being depleted and there is a growing need to beneficiate such ores. Magnetic separation is used, but this is incomplete because magnetite ores have a low porosity and gangue is tightly bound within the particles. The small particle size required for the DRI and H-DRI processes described above assist the release of such tightly bound gangue before injection into the indirectly heated reactors describe in the context of FIGS. 1 and 2.

Notwithstanding the benefits of the small particle size of magnetite for release of tightly held gangue, it has been observed that the reduction rate of low porosity gangue is slow, so the length of indirectly heated DRI and H-DRI reactors is larger than high porosity iron ores such as hematite and goethite. The porosity of such minerals can be enhanced by a process of oxidation of magnetite to hematite in an indirectly heated reactor in which oxygen, or preferably air is introduced into an indirectly heated reactor described above by replacing the reducing gas. During oxidation of magnetite to hematite, the particles decrepitate, swell and crack to give a material which is sufficiently porous that this material, as a synthetic hematite may be injected into the DRI or HDI reactors described above for iron reduction. The energy required to oxidise the magnetite ore is small and the oxygen demand is low. The oxidation in an indirectly heated reactor to iron is carried out to maximise the porosity and surface area to give a material which is reduced more quickly than the original magnetite ore, which means a more compact reactor.

The approach of oxidation of magnetite to a porous synthetic hematite can release the previously tightly held gangue. The synthetic hematite can be injected into the beneficiation process described above in FIG. 3 to further beneficiate the ore as described to produce a higher-grade iron product.

It would be appreciated by a person skilled in the art that the processes described above are generally irreversible process which depend on the mineralogy of the iron ore. The processes described above will vary depending on the mineralogy of the iron ore, and the demand for high grade iron, particularly for a sponge iron that can be directly injected into an EAF with a low emissions footprint. There is often a need to beneficiate ores to remove phosphorous, in which case the beneficiation processes described above can be integrated into the know art for phosphorous extraction.

It would be appreciated by a person skilled in that art to recognise that the advantage of the beneficiation processes described above is that the indirect heatedly DRI or H-DRI reactors use particles instead of pellets so that particle-based beneficiation processes based on magnetic separation of particle are readily integrated into the production of iron using such indirectly heated reactors.

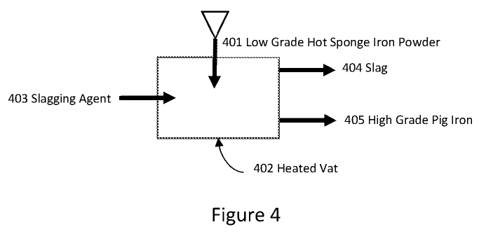

Another approach to beneficiation is to use a flash slagging approach on the iron power produced by a DRI or H-DRI reactors. This approach is illustrated in FIG. 4. The hot iron particles 401 are injected into a heated vat 402 which melts the particles which a slagged by an injection of a slagging agent 403, preferably comprised of lime, dolime or a mixture of both, rather than carbonate materials. Most preferably this material is made from the calcination of limestone, dolomite or magnesite described in the prior art of Sceats et. al. which captures the CO₂ as a pure gas stream for sequestration so the that process is described herein is a low emissions process. The Ca/Mg ratio maybe optimised to extract the gangue using the best known ratios understood from chemical analysis of the gangue. The slag rises the top of the vat and is extracted as a stream 404, and the molten iron is tapped from the vat as a stream 405 using the known arts of slagging to extract these streams and to mix the molten iron and slagging agents. In the subsequent processes (not shown) the slag is cooled using a heat recuperation process and any iron can be recovered using the know art, and the molten iron is preferably cooled and drawn into ingots and cooled to iron. The ingots are a form of pig iron. If desired, coke can be added to the process so that the later production of carbon steel is facilitated.

The most desirable use of the pig iron ingots is for injection into an EAF to make steel, because the residual gangue in the pig iron can be sufficiently low that up 100% of the pig iron can be processed in the EAF if desired, thereby lowering the demand for scrap steel. It is recognised that this process may be desirably carried out as a batch process. The advantage of using the hot powdered sponge iron from the DRI and H-DRI reactors is that the slagging agent is in intimate contact with the iron powder, so that “flash slagging” occurs because the diffusion length of the reactive components of the gangue and the slagging agent are minimised.

### Carbon Sequestration in Iron

Carbon derived from coal is used in the production of mild or carbon steel to specific level to maximise the strength of the steel, while preserving it ductile properties for fabrication and use. Mild and carbon steels are therefore characterised by a significant amount of cementite Fe₃C. Historically, significant amounts of carbon were provided in pig iron feed stock. There is another reason to add carbon to HBI, and that is to passivate the surface. The oxidation of cementite by ambient air or moisture is slow, so a coating of cementite can slow down oxidation. Further, hot iron is pyrophoric as a result of the rapid oxidation, and is a safety hazard for handling DRI. This may be obviated by the HBI process which lowers to iron surface area to inhibit runaway oxidation, but that process does not inhibit oxidation at the exposed surfaces. after compression. There is a benefit of coating the surface of iron with cementite from these perspectives. Importantly, if the carbon is derived from CO₂ that would otherwise be emitted, then the emissions intensity of steel making process would be reduced. Such CO₂ is a small fraction of the current steel emissions, but as noted before, even with H-DRI there are other sources of CO₂ emissions. One example of the emissions is from the CO₂ emission of lime, dolomite or magnesite, which can be captured as a pure CO₂ stream using the prior art of Sceats et al.

The prior art of Stephens teaches that CO₂ stream may be injected with hydrogen transform the iron to cementite through the reaction mechanism

H₂+CO₂ [symbol] H₂O+CO

3Fe+H₂+CO→Fe₃C+H₂O

where it is assumed that the Water Gas Shift reaction is in equilibrium and the H₂O partial pressure is such that the oxidation of iron is suppressed. This art teaches that the reaction rate it too slow if cementite formation it attempted to be carried out with iron ore reduction. The H₂, CO, CO₂ stream may be an offgas of steelmaking processes.

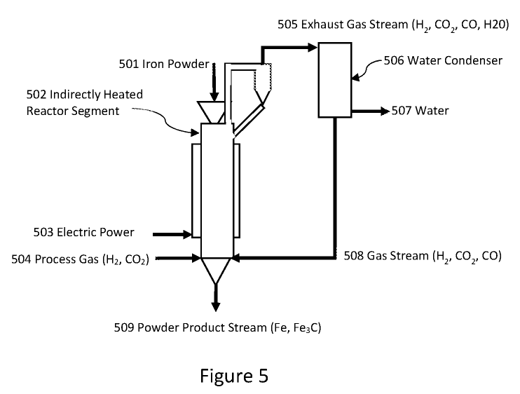

In FIG. 5 the means of coating the surface of iron particles is considered. In this process the hot DRI 501 from the indirectly heated DRI or H-DRI Reactors described above is injected into a second indirectly heated reactor 502, in this case heated by electrical power 503 and the required hydrogen/CO₂ gas mixture 504 in injected at the base. The external heating is controlled to give a fast reaction to produce cementite for the evolving hydrogen/CO₂/CO/H₂O partial pressures in the reactor and to ensure that the conditions for the cementite reaction mechanism are met for given input temperatures of the iron and gas feeds. The exhaust gas 505 is cooled in a condenser 506 to extract water as stream 507 and the residual gas stream 508 of CO, H₂ and CO₂ is recycled. The degree of reaction of iron to cementite in the product 509 will depend on the residence time of the particles in the reactor and the properties of the input iron stream such as the porosity and pore distribution because the cementite product layer resistance will hinder the reaction rate. The solids product 509 is processed as required for the next process in ironmaking and steelmaking.

The degree of reaction of iron to cementite in the product will depend on the residence time of the particles in the reactor and the properties of the input iron stream such as the porosity and pore distribution because the cementite product layer resistance will hinder the reaction rate. Ideally, the cementite product layer at ambient conditions is sufficiently thick to inhibit pyrophoric combustion of the iron so that the powder may be sufficiently stable that the HBI process is ideally, not required for transport to a steel plant. For production of mild steel or carbon steel, the amount of carbon required to be added in steel making may be reduced, preferably to zero.

The combination of beneficiation of low-grade iron and the degree of cementite conversion and carbon sequestration may be achieved together to reduce the process costs for iron and steel production and lower the carbon footprint of steel.

### Scale-Up of Production

The potential disadvantage of indirectly heated reactors for power gas processes it the need to ensure that radiation from the walls can penetrate the cloud of gas and particles. Typically, this limits the single tube reactor dimeter to about 2 metres. While the flux of reactor may be the same as a conventional DRI reactor, the needs of an iron or steel plant are such that multiple tubes will be required for such a plant to achieve throughputs of up to 5,000,000 tonnes-Fe pa. The simplicity of the reactor design is such that modules of reactor tubes may be developed. Multiple modules may be used for a large plant.

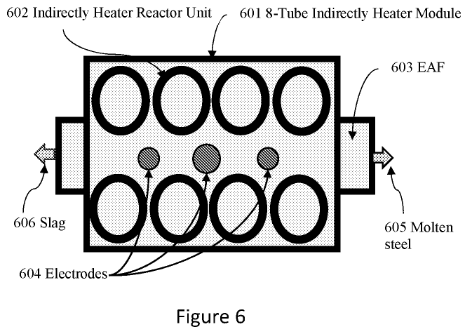

In FIG. 6, an overhead plan of a module of indirectly heated H-DRI reactors are shown coupled to an EAF. The 8-tube module 601 contains 8 indirectly heated reactor unit, such as the reactors of FIG. 1 or 2. Each reactor may, preferably be operated independently. Each reactor delivers hot sponge iron and lime powder into a pond of molten steel in the EAF 603. The EAF is designed as a three-electrode unit with electrodes 604. The EAF is preferably a continuous EAF, under development by the industry, in which molten steel 605 is withdrawn from the base of the EAF and slag 606 is withdrawn from the top of the molten steel. Various means are used to mix the materials in the EAF, and additional materials such as carbon and other metals for alloys are added as required. The modifications to include upgrade of the iron and cementite may be included in a module design for steelmaking.

The modules of tubes described in FIG. 6 may be also applied to the production of low emissions intensity briquettes of iron where the powders at the exhaust of each reactor are collected and injected into an HBI plant. The modifications to include upgrade of the iron and cementite may be included in a module design for iron making.

In modules for ironmaking and steel making each reactor may be able to be operated with independent controls on each tube or the power input powder may be distributed to groups of tube and the hot iron powder streams may be aggerated together. This option for module operations also enables the capability to draw power for production at times when the cost of power and hydrogen are low. A similar approach may be used to preheat the input streams of powder and reducing gas into the reactor. Such preheating is known art, and the best means of preheating will depend on the integrated design.

1. An externally heated vertical reactor for reduction of iron ore, the reactor comprising:
a vertically oriented reactor tube;
a hopper located adjacent to a top end of the reactor tube and configured to input a powder comprising iron ore such that the powder falls downwards in the reactor tube;
reducing gas input ports arranged along the reactor tube from a base of the reactor tube for inputting a reducing gas into the reactor tube;
heating elements positioned vertically adjacent at least one wall of the reactor tube and configured to provide heat to be conducted through the at least one wall, so as to heat the powder and the reducing gas within the reactor tube to a temperature at which the powder and the reducing gas are caused to react;
a gas exhaust positioned adjacent the top end of the reactor tube; and
a reduced iron powder output positioned at the base of the reactor tube.

2-8. (canceled)

9. The externally heated vertical reactor of claim 1, wherein a diameter of the reactor tube is no larger than about 2 m, and a length of the reactor tube is between 10 to 35 m, wherein a residence time of the downflowing iron ore particles is about 10 to 50 seconds, wherein the residence time is dependent on a gas flow direction and cluster formation of iron ore particles of the powder.

10-21. (canceled)

22. The externally heated vertical reactor of claim 1, further comprising deflection plates within the reactor tube configured to deflect the reactor gas and the powder.

23. The externally heated vertical reactor of claim 22, wherein the deflection plates are arranged within the reactor tube adjacent to the reducing gas input ports.

24. The externally heated vertical reactor of claim 1, wherein the reducing gas input ports are arranged to input the reducing gas tangentially into the reactor tube.

25. The externally heated vertical reactor of claim 1, further comprising a gas separator positioned adjacent an entrance to the gas exhaust and configured to remove entrained powder from the reactor gas, the gas separator comprising a metal tube connected to the gas separator, the metal tube passing through a center of the reactor tube and configured to pass the removed entrained powder from the gas separator into the reactor tube.

26. A process for reducing iron ore, the process comprising:
inputting a powder comprising iron ore such that the powder falls downwards in a reactor tube;
inputting a reducing gas into the reactor tube whereby the downwardly falling powder and the reducing gas assume a dilute flow regime; and
indirectly heating the reactor tube so as to heat the falling powder and the reducing gas to a temperature at which the falling powder is caused to be reduced.

27. The process for reducing iron ore of claim 26, comprising inputting the powder at a flux in the range of 0.5-1.0 kg m⁻² s⁻¹.

28. The process for reducing iron ore of claim 26, wherein an average velocity of the downwardly falling powder is less than 3.0 m/s and greater than 0.2 m/s.

29. The process for reducing iron ore of claim 26, wherein a particle size distribution of the powder comprising iron ore is within the range of 25 μm to 250 μm.

30. The process for reducing iron ore of claim 26, wherein a residence time of the downward falling powder is about 10 to 50 s.

31. The process for reducing iron ore of claim 26, further comprising collecting a resultant reduced iron powder product from a base of the reactor tube.

32. The process for reducing iron ore of claim 26, further comprising:
collecting an exhaust gas, wherein the exhaust gas comprises entrained input powder particles;
extracting particles from the exhaust gas and re-inputting the extracted particles into the reactor tube; and
scrubbing the exhaust gas so as to remove gas reaction products therefrom and re-inputting the scrubbed exhaust gas into the reactor tube.

33. The process for reducing iron ore of claim 26, wherein the reactor tube is heated so that a temperature of between 700° C. and 900° C. is reached within the reactor tube, and wherein the heating is controlled along a length of the reactor tube so as to maintain the temperature of between 700° C. to 900° C. within the length of the reactor tube.

34. The process for reducing iron ore of claim 26, wherein the reducing gas comprises carbon monoxide, hydrogen, methane or mixtures thereof.

35. The process for reducing iron ore of claim 26, wherein the reducing gas is tangentially inputted into the reactor tube.

36. The process for reducing iron ore of claim 26, wherein a solids volume fraction for a radiation penetration depth of about a meter is about 1×10⁻⁴ when wall, gas, and particle radiative emissions are accounted for, and wherein walls of the reactor tube are heated to temperatures between 1100° C. and 1700° C.

37. The process for reducing iron ore of claim 26, wherein the process comprises indirectly heating the reactor tube using external combustion or electric power.

38. The process for reducing iron ore of claim 26, wherein a degree of reduction of the powder comprising iron ore is 95% or more.

39. The process for reducing iron ore of claim 26, wherein the powder comprising iron ore comprises hematite, magnetite, goethite, siderite or other iron-based minerals, and mixtures thereof that require reduction of iron for processing the minerals.
